(19) United States
(12) Patent Application Publication
(10) Pub. No.: US 2026/0127951 A1
(43) Pub. Date: May 7, 2026

(54) SYSTEM AND METHOD FOR MONITORING PEOPLE

(71) Applicant: MariElectronics Oy, Vantaa (FI)

(72) Inventor: Göran Sundholm, Tuusula (FI)

(73) Assignee: MariElectronics Oy, Vantaa (FI)

(21) Appl. No.: 19/118,976

(22) PCT Filed: Oct. 20, 2023
(86) PCT No.: PCT/FI2023/050595

§ 371 Date: Apr. 7, 2025

(30) Foreign Application Priority Data
Oct. 28, 2022 (FI) 20225965

(51) Int. Cl. G08B 7/06; G01S 13/04; G01S 13/06; G06Q 30/0201

(52) U.S. Cl. CPC G08B 7/066; G01S 13/04; G01S 13/06; G06Q 30/02011

(57) ABSTRACT

A monitoring system and a method for detecting location of at least one person in a monitored area with a monitoring system, which monitoring system comprises at least one sensor arrangement (101, 201, 301, 302, 303, 304) comprising at least one sensor, measuring electronics and a processor configured to process the sensor data, wherein the sensor is a radar-based sensor, such as frequency-modulated continuous-wave MIMO radar-based sensor, monitoring presence, location, movement and/or attitude of at least one person in the monitored area and, the system determines with the at least one sensor arrangement presence, location and/or movement of at the least one person (402, 403, 404, 405) in the monitored area (200, 401), the system sends information relating to presence, location and/or movement of the at least one person (402, 403, 404, 405) in the monitored area (200, 401) to a device (400, 500), such as a portable device, e.g. a mobile telephone or a tablet, wherein the device (400, 500) indicates the determined presence, location and/or movement of the at least one person (402, 403, 404, 405) in the monitored area in a map or a floor plan of the monitored area.

### FIELD OF THE INVENTION

The invention relates to a monitoring system and a monitoring method using a sensor arrangement which can be utilized e.g. under hazardous situations and evacuation of areas or buildings.

### BACKGROUND

Various systems are known for guiding people in emergency situations to emergency exits of various buildings or ships. These include various emergency exit lighting systems and emergency exits marked with reflective paint or tape, for example.

For example, separate guidance lights designed for emergency exit use are known, in which the light sources are affixed consecutively in the shape of a strip. The light sources on the strip are arranged to light up in an emergency and to guide people and illuminate the way out. Many applications, such as shopping malls, stores, hotels, or passenger ships, have designated escape routes in emergencies that people should follow in evacuation situations. In emergencies, people often do not behave as planned nor follow pre-determined exit routes. There can be many reasons for this. People may not be aware of emergency exit routes and the related signage. In the event of a fire, the signs may be covered in smoke and become invisible. In addition, in emergencies, people prefer to use routes that are familiar to them. On the other hand, in the event of a fire, a pre-determined escape route may be impossible to use due to the location of the threat (such as fire, flood, water damage, violence, etc.) that caused the need to escape, so that known solutions may steer people in the wrong direction or even toward the threat.

Despite of the emergency guidance systems the emergency personnel has to check the area e.g. in a fire situation and in this case the area has to be checked by searching the area for remaining people by the personnel or e.g. fire brigade. This is dangerous and challenging for example in fire situation because the smoke hinders visibility, and the area is dangerous due to the heat and collapsing structures.

The object of the present invention is to provide a completely new type of solution, by means of which the disadvantages of the known solutions are reduced.

### SUMMARY OF THE INVENTION

The purpose of the solution according to the invention is to eliminate the problems of the prior art and to enable a monitoring system which can be utilized e.g. under hazardous situations and evacuation of areas or buildings. The monitoring method according to the invention is characterized by what is mentioned in the characterizing part of claim 1. The monitoring method according to the invention is further characterized by what is mentioned in claims 2-11. The system according to the invention is characterized by what is mentioned in the characterizing part of the method claim 12. The system according to the invention is also characterized by what is mentioned in the characterizing parts of the method claim 13.

Accordingly, the invention relates to a method for detecting location of at least one person in a monitored area with a monitoring system. The monitoring system comprises at least one sensor arrangement comprising at least one sensor, measuring electronics and a processor configured to process the sensor data, wherein the sensor is a radar-based sensor, such as frequency-modulated continuous-wave MIMO radar-based sensor, monitoring presence, location, movement and/or attitude of at least one person in the monitored area and, the system determines with the at least one sensor arrangement presence, location and/or movement of at the least one person in the monitored area. The system sends information relating to presence, location and/or movement of the at least one person in the monitored area to a device, such as a portable device, e.g. a mobile telephone or a tablet. The device indicates or presents the determined presence, location and/or movement of the at least one person in the monitored area in a map or a floor plan of the monitored area.

In one embodiment of the invention the system and/or the device determines location of the device and the location of the device is presented in the map or the floor plan of the monitored area with the determined presence, location and/or movement of the at least one person in the monitored area.

In one embodiment of the invention the location of the device is determined by an indoor positioning system and/or acquired with a GPS positioning function of the device.

In one embodiment of the invention the map of the monitored area comprises an indoor map or floor plan of the monitored area.

In one embodiment of the invention the map of the monitored area comprises position of the at least one radar-based sensor and/or sensor arrangement in the map of the monitored area.

In one embodiment of the invention the at least one sensor of the sensor arrangement is disposed on a floor, wall and/or ceiling of the area to be monitored and/or the measuring range of the at least one sensor arrangement and/or all sensor arrangements essentially cover the area to be monitored.

In one embodiment of the invention the sensor arrangement comprises multiple radar type sensors, e.g. 2-4 radar type sensors, which are arranged to a same structure with each other and/or configured to measure to different directions.

In one embodiment of the invention the system and the device comprise communication means for communicating with each other and wherein the devices comprise software, and a map or a floor plan has been stored in the system and/or the software.

In one embodiment of the invention the system comprises or is connected to an electronic price label system and the electronic price label system stores locations of products or price labels linked to products and the monitoring system or the electronic price label system collects customer product selection event information for a specific product based on the determined location of persons in the monitored area and the determined purchase and/or location information from the electronic label system.

In one embodiment of the invention a fire detector, a smoke detector and/or a flame detector is arranged in connection with the at least one radar based-sensor, e.g. in same enclosure and/or structure with the radar based-sensor.

In one embodiment of the invention the system comprises means for guiding people, such as remotely controlled displays, dynamic signs or light source strips, and the system guides people with the means for guiding people at least in part based on indications of the fire, smoke and/or flame detectors in the monitored area and determined locations of the people, e.g. so that people are guided away from the location of a fire detector that has detected a fire.

The invention relates also to a monitoring system for detecting location of at least one person in a monitored area. The monitoring system comprises at least one sensor arrangement comprising at least one sensor, measuring electronics and a processor configured to process the sensor data, wherein the sensor is a radar-based sensor, such as frequency-modulated continuous-wave MIMO radar-based sensor, configured to monitor presence, location, movement and/or attitude of a person in the monitored area. The system is configured to determine with the at least one sensor arrangement presence, location and/or movement of at least one person in the monitored area. The system is configured to send information relating to presence, location and/or movement of the at least one person in the monitored area to a device, such as a portable device, e.g. a mobile telephone or a tablet. The device is configured to indicate or present the determined presence, location and/or movement of the at least one person in the monitored area in a map or a floor plan of the monitored area.

In one embodiment of the invention the system is configured to implement any method according to any embodiment of the invention.

The invention relates also to a computer program comprising instructions which, when executed by a computer, cause the computer to carry out any method according to any of embodiment of the invention.

The invention relates also to a computer-readable medium comprising the computer program according to the invention.

The monitoring system and method according to the invention have a number of significant advantages. This solution allows the authorities or other personnel to be effectively informed about the people in the area and their location without them being forces to enter and search the dangerous area. This way the authorities, emergency personnel or other stakeholders are able to continuously monitor the situation in hazardous area and rescue the people still present in the area. This is much more effective and safer way to rescue people from the hazardous area than in the prior art solutions in which the authorities and/or emergency personnel have to search the area completely to find remaining persons, which is extremely challenging e.g. during fire when the visibility is minimal. The solution of the invention also can combine different functionalities in one system because people monitoring can be used for different purposes, e.g. for indicating to emergency personnel if there are persons in the area and where the persons are located, and also for monitoring people behavior and routes in the area in normal situation, e.g. in a store environment. With the solution of the invention the safety of the monitored area can be improved, and further functionality can be provided while at the same time keeping installation and hardware costs low.

Various other advantages will become clear to a skilled person based on the following detailed description.

The terms “first”, “second” and “third” are herein used to distinguish one element from other element, and not to specially prioritize or order them, if not otherwise explicitly stated.

The exemplary embodiments of the invention presented herein are not to be interpreted to pose limitations to the applicability of the appended claims. The verb “to comprise” is used herein as an open limitation that does not exclude the existence of also unrecited features. The features recited in dependent claims are mutually freely combinable unless otherwise explicitly stated.

The novel features which are considered as characteristic of the invention are set forth in particular in the appended claims. The invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

The invention is below described in closer detail with the aid of examples and with reference to FIGS. 1 to 6, wherein

FIG. 1 presents in a simplified manner one example embodiment related to sensor arrangement arranged to a store environment,

FIG. 2 presents in a simplified manner one example embodiment in a store environment viewed from above,

FIG. 3 presents in a simplified manner one example embodiment in a store environment viewed from above,

FIG. 4 shows a portable device according to an embodiment of the invention and an application running therein in a fire situation,

FIG. 5 shows a portable device according to an embodiment of the invention and an application running therein in a fire situation, and

FIG. 6 shows in a simplified diagram the operation of monitoring system according to an embodiment of the invention in a situation where the area is to be evacuated.

### DETAILED DESCRIPTION OF THE INVENTION

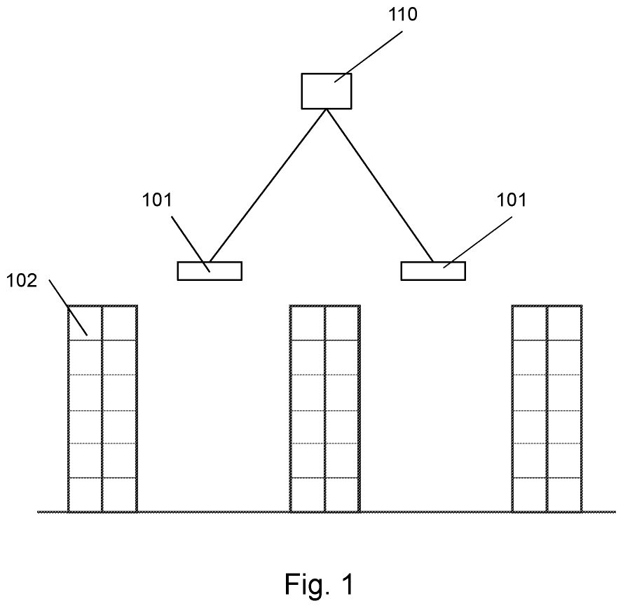

FIG. 1 presents in a simplified manner one example embodiment related to sensor arrangement 101 arranged to a store environment. In this example embodiment the sensor arrangements 101 are arranged above the aisles between the shelves of the store so that sensor arrangements are able to measure an area between the shelves where people are moving and/or detect a person from these areas. The sensors of the sensor arrangement can be arranged so that they are directed directly downwards or slightly tilted. The sensor arrangement 101 can comprise one or multiple sensors and they can be connected to a control unit 110 which controls operation of the sensor arrangement 101. The sensor arrangement can comprise at least one sensor, measuring electronics and a processor configured to process the sensor data. The sensors of the sensor arrangement are a radar-based sensors, such as frequency-modulated continuous-wave MIMO radar-based sensors. In one embodiment of the invention the measuring electronics and/or the processor can be comprised in the control unit and/or with the sensors.

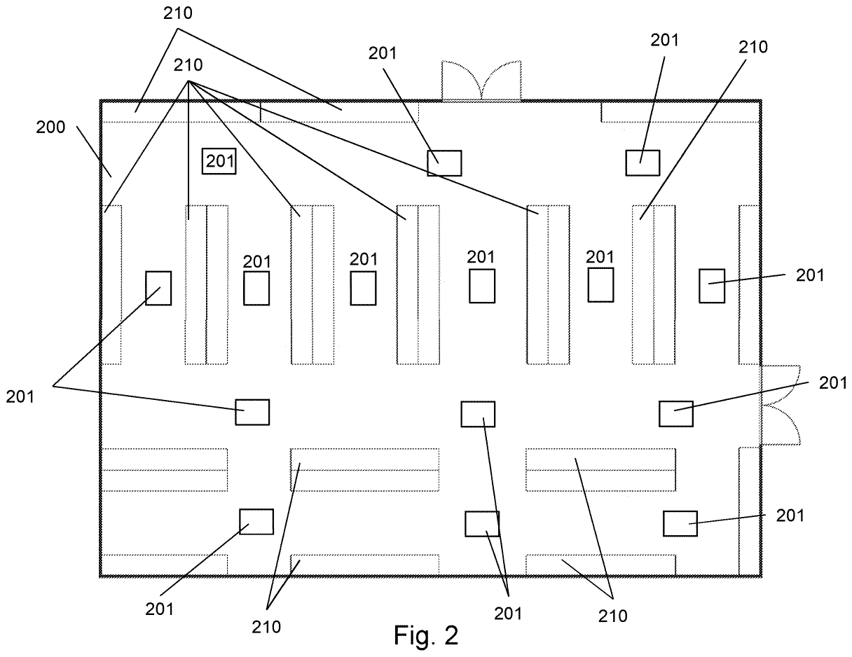

FIG. 2 presents in a simplified manner one example embodiment related to arranging sensor arrangement in a store viewed from above. Also, in this example the sensor arrangements 201 are arranged above the aisles between the shelves 210 of the store so that sensor of the sensor arrangement is able to measure an area between the shelves where people are moving. In this example the measurement area of all the sensor arrangements 201 arranged in the store covers essentially all areas 200 where people can be moving.

The monitoring system determines with the at least one sensor arrangement presence, location and/or movement of at the least one person in the monitored area. In one embodiment of the invention the at least one sensor of the sensor arrangement is disposed on a floor, wall and/or ceiling of the area to be monitored and/or the measuring range of the at least one sensor essentially covers the area to be monitored. The system can combine measurement results from multiple sensors and/or sensor arrangements to achieve reliable positioning of people in the monitored area.

The system sends information relating to the determined presence, location and/or movement of the at least one person in the monitored area to a device, such as a portable device, e.g. a mobile telephone or a tablet. The device indicates or presents, e.g. on its display, the determined presence, location and/or movement of the at least one person in the monitored area in a map or a floor plan of the monitored area and/or as a guiding symbol, such as an arrow, indicating location of at least one person and/or distance between the device and the at least one person. In one embodiment of the invention the map of the monitored area comprises an indoor map or floor plan of the monitored area. In one embodiment of the invention the system comprises a shelf map of the store.

In one embodiment of the invention the system and the device comprise communication means for communicating with each other and wherein the devices comprise software, and a map or a floor plan has been stored in the system and/or the software.

In one embodiment of the invention the system and/or the device determines location of the device and the location of the device is presented in the map or the floor plan of the monitored area with the determined presence, location and/or movement of the at least one person in the monitored area. In one embodiment of the invention the location of the device is determined by an indoor positioning system and/or acquired with a GPS positioning function of the device.

In one embodiment of the invention the map of the monitored area comprises position of the at least one radar-based sensor in the map of the monitored area.

In one embodiment of the invention the sensor arrangement comprises multiple radar type sensors, e.g. 2-4 radar type sensors, which are arranged to a same structure with each other and/or configured to measure to different directions. In one example embodiment one sensor can measure objects up to 15-20-meter distance from the sensor. In one embodiment of the invention in which multiple sensors are used, e.g. if there are two sensors measuring to opposite directions they can together measure for example an area of 30 meters. In this case having measurement area that covers a measured space can be achieved with the sensors so that they are installed with 30 meter spacing.

There exist many different types of fire detectors which can be used with the solution of the invention. One widely used type is the smoke detector, which sends a signal to the control system of smoke generation typical of a fire. Temperature-responsive detectors are also known. In many cases, the fire detectors used have both the characteristics of a smoke detector and a heat detector. Such a fire detector gives a signal of both smoke generation and a temperature which has reached a certain set value. In the event of a fire, smoke spreads over a wide area, so that typically several smoke detectors in fire detectors give an alarm, i.e. a signal. The heat detector, on the other hand, reacts only when the fire is close to the detector, i.e. it reacts more locally to the fire than the smoke detector. In one embodiment of the invention a fire detector, a smoke detector and/or a flame detector is arranged with the at least one radar based-sensor, e.g. in same enclosure and/or structure with the radar based-sensor.

In one embodiment of the invention monitoring of movement of persons comprises monitoring locations where people move, where they are stationary and/or how long people are stationary at a certain location.

In one embodiment of the invention the system comprises or is connected to an electronic price label system and the electronic price label system stores locations of products or price labels linked to products and collects customer product selection event information for a specific product based on the determined location of persons in the monitored area and the determined purchase and/or location information from the electronic label system.

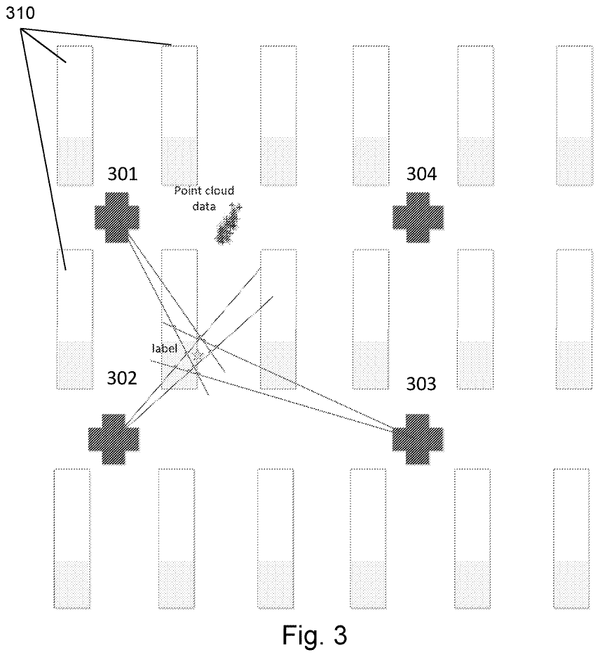

In one embodiment (and as in FIG. 3), a base station of an electronic price label system can be arranged in same location and/or within same structure as the sensor arrangement. This way the installation to the store environment is easy as the wiring and installation can be done in one place for sensor arrangement and base station of the electronic label system. With this solution the system is able to collect locations and/or routes of the persons in the store and also locations and/or routes of the electronic price labels. This arrangement can be installed e.g. in the ceiling of the monitored area.

FIG. 3 presents in a simplified manner one example embodiment related to arranging at least part of the solution of the invention to a store. Each sensor arrangement 301, 302, 303, 304 comprises four radar-based sensors, e.g. MMW-radars, configured to detect movement of the person. The sensor arrangement can have 360-degree view on the monitored area as there are multiple radar-based sensors. The unit comprising the radar-based sensors are arranged above the aisles between the shelves 310 of the store so that sensors are able to measure an area between the shelves where people are moving. The sensors can be arranged so that they are directed directly downwards or slightly tilted. The sensor arrangement can be connected to a control unit which controls operation of the sensor arrangement and/or e.g. a base station of an electronic price label system. FIG. 3 presents also point cloud data from the radar-based sensors of the sensor arrangement 301 as an example corresponding to a moving person in the corridor. In one embodiment the sensor arrangement can be arranged in connection with a base station of the electronic label system. In a direction of arrival detection mode, the base station can send the electronic price labels a command to send signal to the base station, e.g. a Constant Tone Extension (CTE) signal. The base station can comprise an antenna array and the direction of arrival of the signal from the electronic price label can be determined from the antenna array of the base station. With three base stations, the location of the label can be determined.

In one embodiment of the invention, the position of the detected people may be displayed in a software application. The application can automatically display the evacuation route if evacuation from the premises is initiated and the application is open or opened.

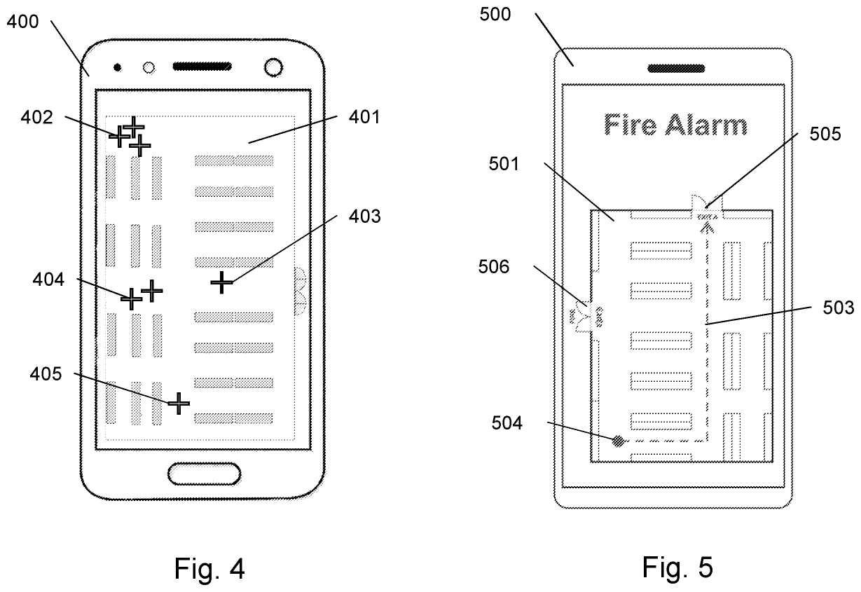

FIG. 4 shows one embodiment of the invention in which a device 400 displays a floor plan 401 of the premises by means of software or an installed application. The floor plan may show, for example, the furniture in the premises and/or the layout and/or structures of the premises. The software can also be used to display the detected persons or group of persons 402, 403, 404, 405 and their location in the map or the floor plan. This way emergency personnel or authorities are able to monitor situation under hazardous conditions, e.g. during fire and people who are still in the monitored area can be evacuated by the personnel based on their indicated location on the display of the device, e.g. a portable device such as a tablet, a phone or a device comprising a display.

One embodiment of the invention also relates to an exit guidance system. The system comprises portable devices or the system is connected to portable devices such as mobile telephones, and the system and the devices comprise communication means for communicating with each other. The portable devices comprise software, and a floor plan of the premises is stored in the system and/or software. The system is arranged to implement guidance of people, such as emergency exit guidance, by means of an application installed on portable devices. The floor plan may comprise location information of objects and/or structures in the premises, such as location information of shelves in a store.

In one embodiment of the invention, the exit guidance system is adapted to send an exit command to the device, and, in response to the command, the device is adapted to start exit guidance in the software, shown on the display of the device. The exit command may include information related to the exit guidance, such as the exit route, the exit door, and/or the location of a fire.

In one embodiment of the invention, the exit guidance system and/or software are adapted to guide the user of the device out of the premises, e.g. to the exit and/or emergency exit of the premises, such as the nearest exit door. Using the software in the device, the system can guide people based on indications of fire detectors in the premises, e.g. away from the location of a fire detector that has detected a fire. The system and/or device and/or software may utilize various known positioning systems and techniques, e.g., indoor positioning systems or techniques, to determine the location of the device and/or to modify and adapt guidance based on the location of the device.

In one embodiment of the invention, the exit guidance system and/or software are adapted to generate guidance by showing on the display of the device a route to the exit, wherein the route is adapted to be drawn as a line and/or consecutive and/or adjacent symbols such as dots or circles. The guidance can be performed by making the consecutive and/or adjacent symbols “run”, e.g. by changing their color and/or making the symbols smaller and/or bigger. The symbols may have two states, a normal state and a guidance state, and the impression of motion is created by controlling the symbols in groups so that when the appearance of the next symbol enters the guidance state, e.g. by changing the color and/or making the symbol smaller and/or bigger, the appearance of the preceding symbol enters the normal state.

One embodiment of the invention also relates to an exit guidance method that may be used in an exit guidance system comprising portable devices or the system is connected to portable devices such as mobile telephones, and the system and devices comprise communication means for communicating with each other, wherein the portable devices comprise software, and wherein a map or floor plan of the premises has been stored in the system and/or software. The method implements the guidance of people, such as emergency exit guidance, by means of an application installed on portable devices in the system.

FIG. 5 shows a portable device according to an embodiment of the invention and an application running therein in a fire situation. The solution shown in FIG. 5 otherwise corresponds to the solution shown in FIG. 4, but in the solution of FIG. 5 the software or installed application does not show location of people in the area but guides the person using the device to an exit. FIG. 5 thus shows a device 500 which displays a floor plan 501 of the premises by means of software or an installed application. The floor plan may show, for example, the furniture in the premises and/or the layout and/or structures of the premises. The software can be used to show, on a display, the route to exit 503 as well as the first exit 505 and the second exit 506 and/or the location 504 of the person and/or device in the premises. In one embodiment of the invention position of people in the area can also be shown in the emergency guidance view.

In one embodiment of the invention the device can show both the determined location of people in the monitored area and at least one route to exit.

In one embodiment of the invention the system comprises means for guiding people, such as remotely controlled displays, dynamic signs or light source strips, and the system guides people with the means for guiding people at least in part based on indications of the fire, smoke and/or flame detectors in the monitored area and determined locations of the people, e.g. so that people are guided away from the location of a fire detector that has detected a fire. The monitoring system and/or a guiding system connected to the monitoring system can utilize in the dynamic guiding the determined locations of people in the monitored area and/or number of people in certain parts of the area for guiding purposes, e.g. so that people are guided away from the hazardous area so that no or minimal congestion is caused by guiding. This can be enabled by directing people with the guiding means to different exits based on the detected number of people and their location.

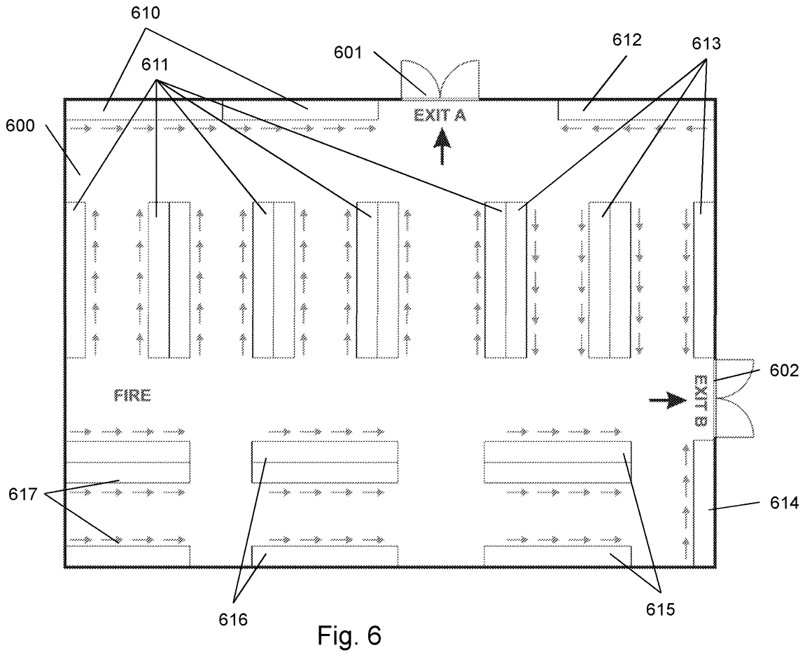

FIG. 6 is a simplified diagram showing the operation of monitoring system according to an embodiment of the invention in the event of a fire in the area. Fire detectors are arranged in premises, such as a store, which can have, for example, both smoke detection and heat detection functionalities. Guiding means can be arranged to the monitored area, e.g. on the on the edges of the shelves. The premises shown in FIG. 6 have two exits 601 and 602.

The guiding means can be arranged to guide people to the nearest available exit. The arrows in the figure illustrate the guidance direction of the guiding means. In FIG. 6, the guiding means on shelves 611 guide upwards in the figure, i.e. to the part of the premises 600 where an exit 601 is located. Guiding means arranged on the shelves 610, 612 arranged peripherally in the premises guide laterally in the figure, directly towards a first exit 601. Guiding means arranged on the other shelves 613, 614, 615, 616, 617 guide to the part of the premises where a second entrance 602 is located.

In one embodiment of the invention, the system is adapted to flash the light sources of adjacent guiding means. An impression of movement can be created by controlling the light sources of the guiding means in groups. Control for the light sources can be implemented, for example, in such a way that when the light source of the next guiding means is switched on, the light source of the preceding guiding means is switched off. In one embodiment of the invention, control for the light sources can be implemented in such a way that the light sources of a group of several guiding means (e.g. a group of two or three guiding means) are switched on, the light sources of the preceding group of guiding means are switched off.

In one embodiment of the invention, the guiding effect is produced by the light sources of adjacent guiding means. Such a solution can be used, for example, if the guiding means has one light source only. If the guiding means comprises multiple light sources, the guiding effect, i.e. the impression of movement, can be produced by means of the light sources of one guiding means and/or jointly by means of the light sources of adjacent guiding means.

In one embodiment of the invention, the light sources of the guiding means may have at least two modes: a static mode and a dynamic mode in which the light sources are switched on and off so as to create the impression of movement. In this embodiment, the light sources of the guiding means can be controlled to switch between dynamic and static modes.

In one embodiment of the invention, the system is adapted to guide using substantially all guiding means in the premises.

In one embodiment of the invention, the system is adapted to switch on at least part of the light sources in the monitored area and keep them lit when the premises need to be evacuated, e.g. based on an indication by fire detectors.

In one embodiment, in addition to or instead of the above-mentioned guiding means, an arrow may be used in addition on the display to indicate the direction of exit. In one embodiment, the display or arrow pattern may be illuminated.

An example of how to create a guidance effect is explained below by way of example. In this technique, the light sources of successive guiding means are controlled so that the light sources of adjacent guiding means form a guidance effect that can indicate the desired direction of exit in the premises so that people can follow that direction when exiting in an emergency. Thus, a person who sees the impression of the movement produced by the light sources of the guiding means is guided in the direction of the “movement” of the light sources of the guiding means. Typically, the impression of movement is obtained by controlling the light sources in groups, where movement is indicated by switching on the next light source and switching off the preceding one. In this way, an impression of movement is created with the light sources, i.e. said impression of movement is created by a “flowing” light. The “moving” light created by the light sources of the guiding means can typically be formed, for example, from groups of 3 light sources, where the light of one light source of the guiding means is switched on and the other two are switched off. Movement occurs when the light source of the next guiding means is turned on and the light source of the preceding guiding means is turned off. The impression of movement can also be created by switching the light sources of groups consisting of several guiding means alternately on and off. The speed of the movement produced by the light can be adjusted as desired and its direction can also be changed. If an guiding means has several light sources, it is also possible to control several light sources of the same guiding means to create the movement, i.e. by lighting adjacent light sources of the single guiding means in the above-mentioned manner. In one embodiment of the invention, the impression of movement can be created by flashing the light sources of a single guiding means and/or by flashing the lights of the light sources of guiding means.

In one embodiment of the invention, the system is adapted to implement the guidance of people, such as emergency exit guidance, by flashing guidance light sources of a single remotely controlled display so that the flashing produces the impression of movement. In this case, the remotely controlled display, such as an electronic price tag, has several light sources for guidance. In one embodiment of the invention, the system is adapted to implement the guidance of people, such as emergency exit guidance, by flashing the light sources of adjacent remotely controlled displays, such as electronic price tags, so that the flashing of the light sources produces an impression of movement. In this case, a remotely controlled display, such as an emergency guiding display or an electronic price tag, may have one or more light sources used for guidance. In one embodiment of the invention, the guidance function may be implemented as a combination of the above examples.

The light sources of the guiding means can be controlled by the monitoring system or a control system connected to it, the monitoring system and/or control system being able to receive signals from one or more fire detectors connected to it, typically installed in many buildings or premises.

In one embodiment of the invention, the system is adapted to guide people out of the premises, e.g. to the exit and/or emergency exit of the premises, such as the nearest exit door, by flashing the light sources of guiding means. The system can guide people using the light sources of guiding means on the basis of indications of fire detectors in the premises, e.g. away from the location of a fire detector that has detected a fire. Light sources of guiding means arranged side-by-side can be controlled based on a signal from at least one fire detector. In one embodiment of the invention, the guidance function of the system can be activated from the system manually, e.g. by a user of the system. In one embodiment of the invention same exit routes can be displayed on the displays of the devices, e.g. portable devices, present in the area.

In one embodiment, the system according to the invention is adapted to operate in such a way that the guidance functionality produced by the light sources of the guiding means is activated in a situation where two or more fire detections have been received from a detector arranged in the same premises as guiding means. The activated guidance function can then enter a guidance mode, such as a static guidance mode and/or dynamic guidance mode. If a dynamic guidance mode is used, the guidance effect can be adapted to guide people in the direction of a suitable exit, for example by changing the state of the light sources to create an impression of a “flowing light”, for instance. In one embodiment of the invention similar kind of guiding can be displayed on the displays of the devices, e.g. portable devices, present in the area.

In one embodiment an electronic price label system can be arranged to the monitored area, e.g. in a store or in similar sales premises. Electronic price labels can be affixed to the shelves in the premises. The electronic price label display is arranged to display product-related information, such as price, product name, and possibly some other product-related information. Electronic price labels can communicate with the rest of the system via base stations.

The body of the electronic price label may be hard or elastic and flexible in material and structure. The electronics of the electronic price label can be placed inside or in connection with the body of the label. The display of the electronic price label is equipped with display segments or pixels. The electronic price label may have an opening or other attachment means for attaching the electronic price label to a desired location, e.g., the edge of a shelf.

An electronic price label system according to an embodiment of the invention may include, in addition to electronic price label, at least communication means, such as a central unit with communication means, through which updated price information and other control information for electronic price labels can be sent and received via base stations in the system. In addition, scanners at checkouts, which are connected to the cash register system and scan the products, may be connected to the system, wherein the cash register system and the electronic price labels always have the same and up-to-date product price information. The central unit may be further connected to other control and support systems.

An electronic price label used in the system according to an embodiment of the invention comprises communication means by means of which it can communicate with the electronic price label system and/or the monitoring system.

In one embodiment of the invention the customer product selection information which is determined in the solution of the invention can comprise number of products sold in a certain time, e.g. during an hour and/or during a day, for a certain location at the store, e.g. for a certain shelf, and/or information relating to how a certain product has been sold in respect to the other products.

With the sensors used in the solution of the invention a “heat map” type of image at different times can be provided from which it can be seen how many customers have been moving in a certain time in certain areas and corridors. This information can be used for example for targeted marketing and pricing. In one embodiment of the invention the sensor arrangement are used to determine that a certain product is taken from the shelf and/or put back to shelf, and/or this way heat mapping data of a certain shelf can be firmed and/or provided.

It will be apparent to those skilled in the art that the various embodiments of the invention are not limited to the examples set forth above, and may therefore vary within the scope of the claims set forth below. If necessary, features presented in the description together with other features may also be applied separately from each other.

1. A method for detecting location of at least one person in a monitored area with a monitoring system, wherein:
the monitoring system comprises at least one sensor arrangement comprising at least one sensor, measuring electronics and a processor configured to process the sensor data, wherein the sensor is a radar-based sensor, such as frequency-modulated continuous-wave MIMO radar-based sensor, monitoring presence, location, movement and/or attitude of at least one person in the monitored area and,
the system determines with the at least one sensor arrangement presence, location and/or movement of at the least one person in the monitored area,
the system sends information relating to presence, location and/or movement of the at least one person in the monitored area to a device, such as a portable device, e.g. a mobile telephone or a tablet,
wherein the device indicates the determined presence, location and/or movement of the at least one person in the monitored area in a map or a floor plan of the monitored area.

2. A method according to claim 1, wherein the system and/or the device determines location of the device and the location of the device is presented in the map or the floor plan of the monitored area with the determined presence, location and/or movement of the at least one person in the monitored area.

3. A method according to claim 1, wherein the location of the device, is determined by an indoor positioning system and/or acquired with a GPS positioning function of the device.

4. A method according to claim 1, wherein the map of the monitored area comprises an indoor map or floor plan of the monitored area.

5. A method according to claim 1, wherein the map of the monitored area comprises position of the at least one radar-based sensor and/or the sensor arrangement in the map of the monitored area.

6. A method according to claim 1, wherein the at least one sensor of the sensor arrangement is disposed on a floor, wall and/or ceiling of the area to be monitored and/or the measuring range of the at least one sensor arrangement and/or all sensor arrangements essentially cover the area to be monitored.

7. A method according to claim 1, wherein the sensor arrangement comprises multiple radar type sensors, e.g. 2-4 radar type sensors, which are arranged to a same structure with each other and/or configured to measure to different directions.

8. A method according to claim 1, wherein the system and the device comprise communication means for communicating with each other and wherein the devices comprise software, and a map or a floor plan has been stored in the system and/or the software.

9. A method according to claim 1, wherein the system comprises or is connected to an electronic price label system and the electronic price label system stores locations of products or price labels linked to products and the monitoring system or the electronic price label system collects customer product selection event information for a specific product based on the determined location of persons in the monitored area and the determined purchase and/or location information from the electronic label system.

10. A method according to claim 1, wherein a fire detector, a smoke detector and/or a flame detector is arranged in connection with the at least one radar based-sensor, e.g. in same enclosure and/or structure with the radar based-sensor.

11. A method according to claim 1, wherein the system comprises means for guiding people, such as remotely controlled displays, dynamic signs or light source strips, and the system guides people with the means for guiding people at least in part based on indications of the fire, smoke and/or flame detectors in the monitored area and determined locations of the people, e.g. so that people are guided away from the location of a fire detector that has detected a fire.

12. A monitoring system for detecting location of at least one person in a monitored area, wherein:
the monitoring system comprises at least one sensor arrangement comprising at least one sensor, measuring electronics and a processor configured to process the sensor data, wherein the sensor is a radar-based sensor, such as frequency-modulated continuous-wave MIMO radar-based sensor, configured to monitor presence, location, movement and/or attitude of a person in the monitored area, and
the system is configured to determine with the at least one sensor arrangement presence, location and/or movement of at least one person in the monitored area,
the system is configured to send information relating to presence, location and/or movement of the at least one person in the monitored area to a device such as a portable device, e.g. a mobile telephone or a tablet,
wherein the device is configured to indicate the determined presence, location and/or movement of the at least one person in the monitored area in a map or a floor plan of the monitored area.

13. A system according to claim 12, wherein the system is configured to determine location of the device and the location of the device is presented in the map or the floor plan of the monitored area with the determined presence, location and/or movement of the at least one person in the monitored area.

14. A non-transitory computer readable medium storing a computer program comprising instructions which, when executed by a computer, cause the computer to carry out the method according to claim 1.

15. A non-transitory computer-readable medium storing a computer program comprising instructions which, when executed by a computer, cause the computer to carry out the method according to claim 2.

16. A method according to claim 2, wherein the location of the device is determined by an indoor positioning system and/or acquired with a GPS positioning function of the device.

17. A method according to claim 2, wherein the map of the monitored area comprises an indoor map or floor plan of the monitored area.

18. A method according to claim 3, wherein the map of the monitored area comprises an indoor map or floor plan of the monitored area.

19. A method according to claim 2, wherein the map of the monitored area comprises position of the at least one radar-based sensor and/or the sensor arrangement in the map of the monitored area.

20. A method according to claim 3, wherein the map of the monitored area comprises position of the at least one radar-based sensor and/or the sensor arrangement in the map of the monitored area.
